(19) United States
(12) Patent Application Publication
(10) Pub. No.: US 2003/0136204 A1
(43) Pub. Date: Jul. 24, 2003

(54) Self extricating independent ballistic material core sampler

(76) Inventor: Timothy J. Bergquist, Golden, CO (US)

Correspondence Address: Timothy J. Bergquist, 111 Washington Avenue, Golden, CO, 80401, US

(21) Appl. No.: 10/056,847

(22) Filed: Jan. 23, 2002

(51) Int. Cl. G01N 1/08

(52) U.S. Cl. 73/864.44; 73/864.45

(57) ABSTRACT

A hollow cylinder (12) surrounded within the helical coil of an extricating compression spring (10) filled at its breech and sharpened at its open front end for penetrating and capturing samples of material. The assembly itself is a projectile, or is attached to a projectile (24) which conveys it to a remote sample location and imbeds it into the sample material with inertia. The assembly is held together with keeper pins (22) inserted through common holes. The imbedded core barrel (12) with its sample chamber filled with a representative sample of material extricates itself from the host matrix by means of an extricating compression spring (10) releasing its force against the surface of the host material. Once self-extricated and distanced from the sampled material it falls to the nearest horizontal surface.

### BACKGROUND

1. Field of Invention

This invention relates to acquiring representative core samples of materials for laboratory analysis from locations inaccessible or inhospitable to the human body, specifically, independent of physical connections to the point of origin, it travels to a material, penetrates it, captures a representative sample, extricates itself, then distances itself with a sample from potentially dangerous host materials.

2. Description of Prior Art

Core sampling is a long-standing common practice to determine the nature and content of unknown materials. There are numerous core-sampling devices in use today serving a variety of industries. All core-sampling devices have two things in common: 1) They extract a representative cross section of material from a larger host matrix material, and 2) they are physically connected to a means required to both implant and remove the device from the host matrix in which the sample material resides and is extracted from. Among all the prior art involving coring devices, there are none that enables a core sample of material to be taken at any distance that is independent of any physical contact to the point of origin. Further, a comprehensive search of core devices has been unable to locate any device capable of independently extricating itself and a sample from a host matrix material.

All previous art includes devices that require a drill or a hammer action applied directly to the breech of the core sample barrel to imbed the device into the material desired for analysis. Once the desired material has been penetrated a reverse pulling and/or twisting force is required to extract the device and its captured core sample. Every step of conventional core sampling requires a direct physical connection between the core sample barrel and the point of origin.

Small coring devices are used to take cross-section cores of trees to count and measure the distance between annual growth rings. Other coring devices are used to penetrate glaciers to determine the length of ancient winters. Yet other core sampling devices measure local immediate snow-pack as well as others that record the history of arctic ice sheets. Larger core sampling devices take representative cores of coal beds from inches in thickness to hundreds of feet. Oil and natural gas core tools retrieve reservoir portions of sedimentary rock formations from thousands of feet beneath the surface. All require direct physical contact with the origin to reach the material, penetrate it, and extricate the core sample along with the device used to capture the sample from the host material. None utilize a self extricating core sampler.

There are two small core-sampling devices available for sampling building materials for asbestos content. This art represents the closest comparison in terms of primary end result, but the functionality to attain that end result bears no similarity. Neither of the prior art is self extricating or capable of independently taking a sample at any distance. One is the Wondermakers Bulk Sampling Kit available through Environmental Monitoring Systems, 164 Ashley Avenue, Charleston, S.C. 29403, 843-724-5708. The other is the Copper Bulk Sampling Kit also available through Environmental Monitoring Systems. Neither device is capable of independently capturing a sample, then extricating and distancing itself with the sample from the host material. The core barrel of both can be used only once. Therefore, there is no prior art to my knowledge, only different devices that partially perform a similar function.

### OBJECTS AND ADVANTAGES

Accordingly, in addition to the objects and advantages of eliminating human exposure to toxic and hazardous environments and facilitating the identity of such environments, other obvious objects and advantages of the present invention are as follows:

(a) Materials that are difficult or impossible for the human body to reach can be easily and inexpensively sampled from a distance, thereby minimizing the requirement under the EPA Asbestos Hazard Emergency Response Act to assume a material is containing toxic substances due to the inability to obtain a sample.

(b) It adjusts easily from a hardness of 1 (Moh's hardness scale) to materials in excess of hardness 6 and just as easily compensates to various thickness and distance from access to the location of materials desired for sampling.

(c) It can be transported and operated by one person easily and safely.

(d) The core barrel and sample chamber are reusable further eliminating cost.

(e) It can reach heights in a fraction of the time and at a fraction of the cost of conventional man-lift methods.

(f) It is capable of taking ten samples from a height of eighty feet in the time a hydraulic lift can lift a human to take one sample (proven at the former Stapleton International Airport demolition of Hangar 4, November 2000).

(g) It can be easily mass-produced with commonly available materials.

(h) It is a simple durable design requiring no maintenance.

(i) It is small, easy to store and transport, and can be used safely virtually anywhere.

(j) It is nearly silent creating negligible noise pollution and has a unique appearance and dynamic function making it a novelty to observe in use.

(k) It is precise in its accuracy and can be used by anyone familiar with the use of firearms or archery.

(l) This core sampler is simplistic in its design yet precise in its function.

(m) A device containing a captured sample can be replaced by an unused device on a projectile in a matter of seconds to facilitate rapid successive sampling.

(n) It eliminates the need to carry ladders or arrange for expensive leased mechanical lifts.

(o) It is inexpensive to manufacture and durable enough to last indefinitely.

(p) It is fan to use.

(q) As long as buildings are going to be demolished and renovated there will be a need for this device.

(r) Even when used as a conventional core sampler within arms reach of a human it will still extricate itself and the sample from the host material making it superior to any device presently in use for this purpose.

(s) It adapts in seconds to almost any combination of physical parameters of solid materials allowing a sample to be captured consistently at variable distances.

Further objects and advantages are to provide a method of acquiring a representative sample of suspect toxic material for analysis from areas that pose a physical or health hazard to the human body, which is simple yet accurate to use and inexpensive to manufacture, which is easily transported and stored, which operates silently while functioning flawlessly, which can be used repeatedly with minimal maintenance, and which obviates the necessity of expensive and cumbersome auxiliary equipment to span heights or negotiate prohibitive distances. Still further objects and advantages will become apparent following a consideration of the ensuing description and drawings.

### DRAWING FIGURES

In the drawings, closely related figures have the same number but different alphabetic suffixes.

FIG. 1-A is a schematic drawing showing all parts, including hidden internal parts (in dashed lines) of a fully assembled prototype device, with through holes.

FIG. 1-B is a shaded drawing of the fully assembled prototype device.

FIG. 1-C is a shaded drawing of the cross section of the fully assembled prototype device, with through holes.

FIG. 2-A is a schematic drawing of all the individual parts of the unassembled prototype device, with through holes.

FIG. 2-B is a shaded drawing of all the individual parts of an unassembled prototype device, with through holes.

FIG. 3 is a schematic drawing of the hollow cylinder core barrel and sample chamber detailing the ground or milled shape of the cylinder walls and detailing the shape of the of the penetrating edge, with through holes.

FIG. 4 is a front and back longitudinal cross-section view of the individual parts of the variable diameter projectile connecting assembly, with through holes.

FIG. 5 is a front and back longitudinal cross-section view of a partially assembled variable diameter projectile connecting assembly, with through holes.

FIG. 6 is a front and back longitudinal cross-section view of a fully assembled variable diameter projectile connecting assembly, with through holes.

### REFERENCE NUMERALS IN DRAWINGS

10 extricating compression spring

12 hollow cylinder core barrel and sample chamber

14 first sizing sleeve of variable diameter projectile connecting assembly

16 second sizing sleeve of variable diameter projectile connecting assembly

18 third sizing sleeve of variable diameter projectile connecting assembly

20 solid projectile connecting rod

22 keeper pin

24 projectile

Summary

With respect to present methods for bulk sampling of building materials for asbestos content, but not limited to that specific field, this invention is far superior to all conventional procedures, methods and prior art. It eliminates sampling obstacles including heights, distances and inhospitable locations prohibitive to human occupancy. It is deployed independently to the sample location on a projectile, or as a projectile itself, and extricates itself free of the material from which it has captured a representative sample. It is the only sampling device capable of these accomplishments. It surpasses every known methodology and exceeds all federal compliance standards for dealing with regulated materials.

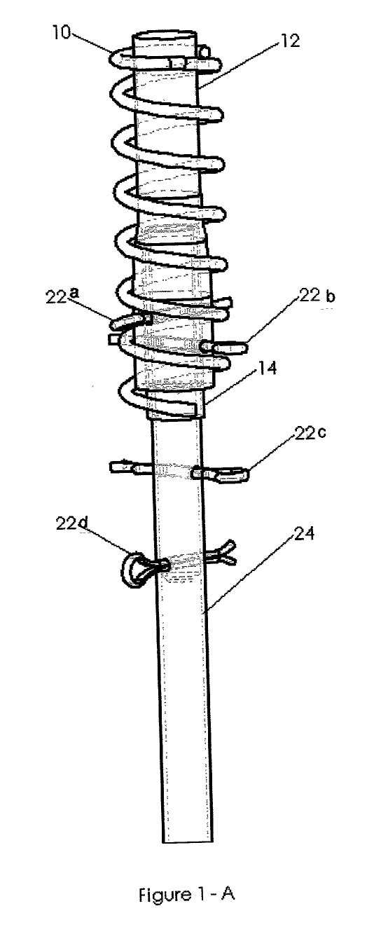

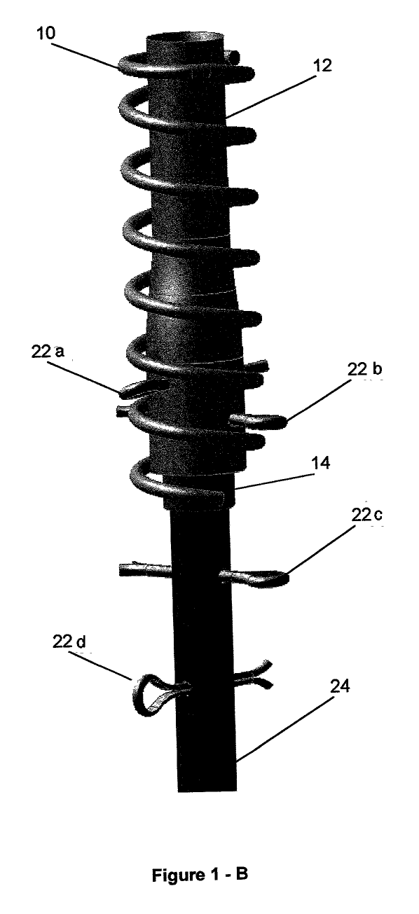

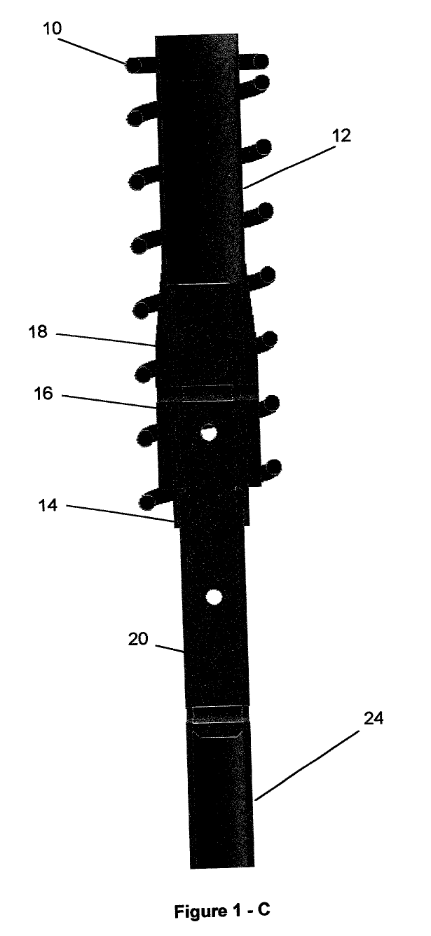

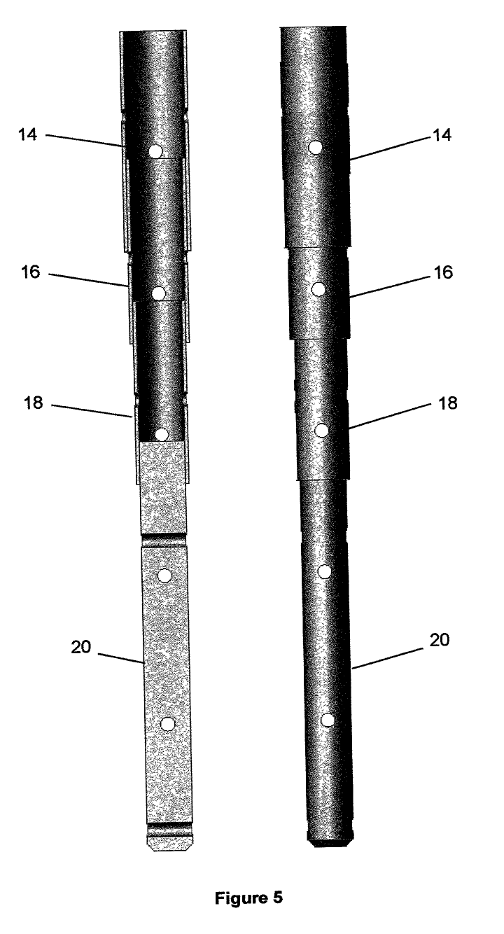

Description—FIGS. 1 to 6

A typical embodiment of the present prototype of the Self Extricating Ballistic Material Core Sampler is illustrated in FIG. 1-A (schematic view), FIG. 1-B (shaded drawing) and FIG. 1C (assembled cut-away cross-section). The primary function of the device occurs in a hollow cylinder core barrel and sample chamber 12. This must be a durable material capable of withstanding high velocity impacts (250 ft./sec. range) with other hard materials (in excess of Moh's hardness 6). In the preferred embodiment the core barrel 12 is stainless steel tubing with an inside diameter of 1 centimeter, commonly available in various sizes from ALCAM Metal Distributors, Inc. 4894 Van Gordon Street, Suite #302, Wheatridge, Colo. 80033.

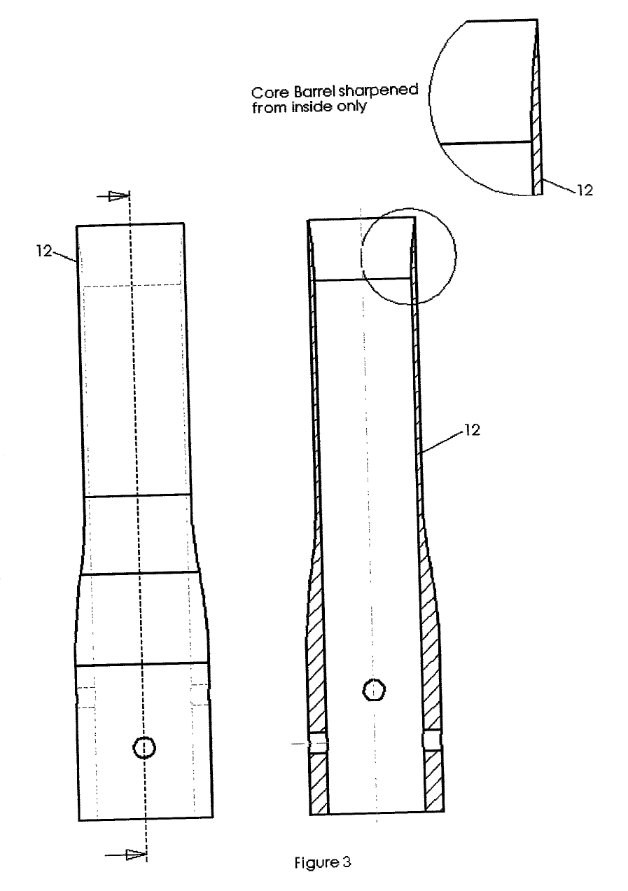

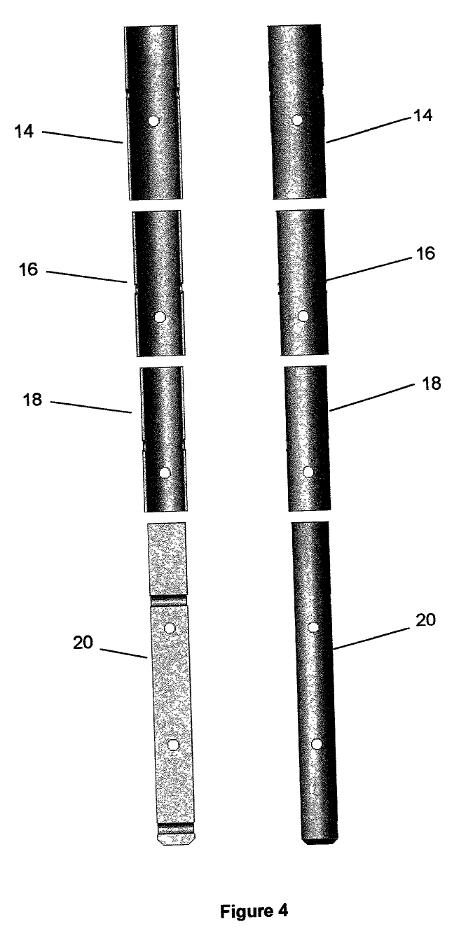

The exterior of the core barrel 12 is shaped with a bench grinder or milling with a lathe. FIG. 3 illustrates the thinning of the outside upper wall to a sharpened opening. The detail in FIG. 3 emphasizes sharpening the opening from the inside only. This is essential in allowing the core barrel 12 to penetrate materials of hardness 4.5 and above at high velocity without collapsing inward. The breech of the core barrel 12 is filled by fitting within a variable diameter projectile connecting assembly and a solid projectile connecting rod 20, illustrated in various stages of assembly in FIGS. 4, 5 and 6.

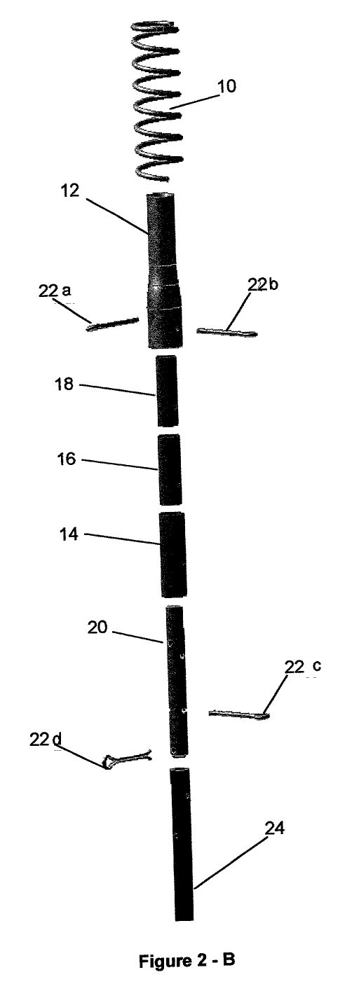

FIG. 2-A and FIG. 2-B illustrate the individual parts of the embodiment in successive order from the exterior assembled inward.

The secondary function of the device is accomplished by means of a extricating compression spring 10 used to free the core barrel 12 once it has penetrated a material. The spring 10 slides over and surrounds the core barrel 12, FIGS. 1-A, B &C.

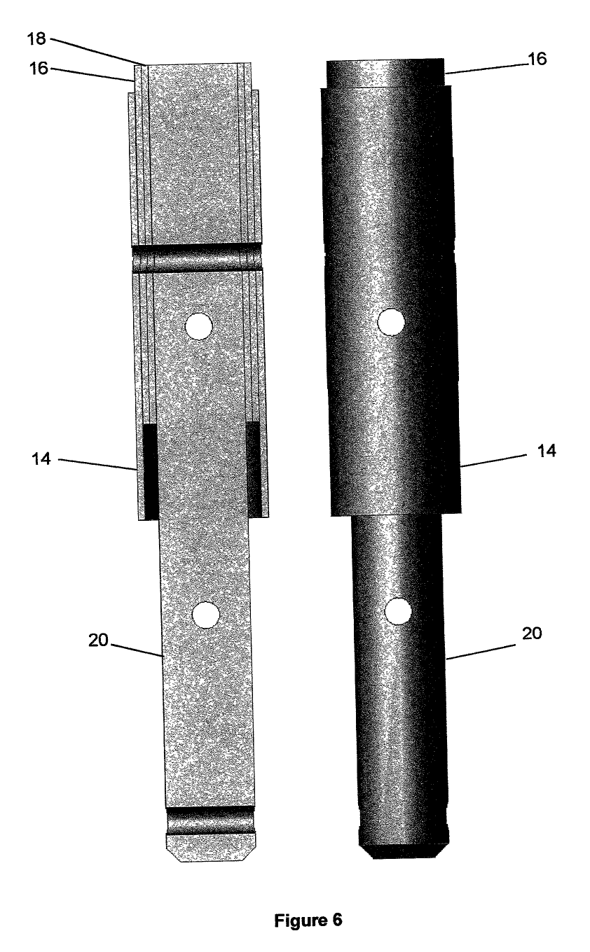

The projectile connecting assembly is comprised of a series of sizing sleeves, 14, 16 and 18, which telescope sliding into one another adjusting the inside diameter of the core barrel 12 bore either up or down to the desired diameter of a projectile 24. A sizing sleeve 14 used in this prototype embodiment is brass tubing. A sizing sleeve 16 is the next size smaller brass tube, with its outside diameter equal to the inside diameter of sizing sleeve 14. A sizing sleeve 18 is the next size smaller brass tubing with its outside diameter equal to the inside diameter of sizing sleeve 16. In this way the inside diameter of the breech bore of the core barrel 12 can be adjusted up or down to mate with any size determined by the type of projectile preferred. This brass tubing is readily available at most hardware stores, all hobby shops and can be ordered in quantity from industrial tubular supply wholesalers. With the variable diameter assembly fitted into the breech of the core barrel 12 a solid projectile connecting rod 20 is then fitted inside the variable diameter assembly, illustrated in FIG. 6 and held in place by a keeper pin 22a and 22b inserted through all parts at right angles to each other and offset, via holes drilled through all the parts in place. The present prototype embodiment used a common ¼ inch I.D. aluminum shaft hunting arrow as a projectile 24 and the ¼ inch solid rod 20 fit perfectly inside the shaft of the projectile 24. The solid rod 20 used is brass or aluminum and held in place inside the projectile 24 with keeper pins 22c and 22d inserted through all parts at right angles to each other and offset, via holes drilled through all parts in place. The preferred embodiment selected brass instead of aluminum to increase mass and thereby increase penetrating force.

The extricating compression spring 10 is held in place by threading the helical coils of the spring between and around the protruding ends of keeper pins 22a and 22b. The coil of the spring 10 acts as threads of a screw against the protruding ends of the pins 22a and 22b which act as grooves, such that the spring will not slide up and down along the outer wall of the cylindrical core barrel 12 but rather traverse up and down screw-like with rotation, FIGS. 1-A and 1-B. In this manner different compression lengths in relation to force exerted, or k-factors, of extricating springs 10 can be refitted in seconds in the field. Extricating spring 10 will have a compression to force relationship, k-factor, determined by the accessible distance from to the material's location and the hardness and thickness of the material to be sampled. The harder materials at a difficult distance, 100 feet above ground level for example, to be sampled will require a greater launch velocity, 250 to 300 ft./sec, of the projectile and a greater k-factor, less compression per unit of force, or more powerful, extricating spring. Likewise, a soft material to be sampled at a closer distance, 25 feet horizontally for example, will require a low launch velocity (100 ft./sec.) with a weaker k-factor extricating spring, and so on. Launch velocity and k-factor value for hardness of material versus distance for each material to be sampled can be calculated precisely. Testing proved this to be a futile exercise as laboratory models and field reality rarely coincide. With four consistent velocity settings, explained below, and three different k-factor springs a novice becomes an expert with a good feel for which combination to use in any given situation with very little hands-on time in the field. A variety of size and k-factor compression springs can be purchased from most hardware stores.

The keeper pin 22 can be a cotter pin, compression pin, small machine screw and nut, snap pin or threaded set-screw. The present prototype embodiment found cotter pins to be the most practical.

The projectile 24 can be anything capable of deploying the self-extricating core sampler into the material to be sampled. With the right means of propulsion the sampler itself can be a projectile. The present prototype embodiment tested projectiles comprising a bow and arrow, cross-bow and bolt and an expanding gas through combustion ‘Potato Gun’ all with satisfactory results. The material to be sampled was the upper portion of a wall eighty feet high and three hundred fifty-six feet long in the center of a large hangar. Obstacles from origin to sampling point were many steel beams, pipes, wires, lights, catwalks and hoists yielding a window to the target as small as six square inches. The present embodiment prototype used an aluminum shaft arrow and a full recurve sixty-five-pound-pull hunting bow initially, but found a cross-bow and bolt more user friendly and accurate for the non-expert archer. The entire wall was successfully sampled. A cross-bow launching the device on the end of a bolt is the advised method of conveyance to a remote or inhospitable sample location. The shoulder launched or hand-held cross-bows work equally well, with the former providing greater range in distance and launch velocity. The advantage of the cross-bow is that it is easily adapted to a variety of string tension settings. Four tension settings between neutral string and fully pulled string provides four different consistent velocities at launch. This set of consistent velocities in conjunction with easily interchangeable K-factor extricating springs 10 ensures sample capture and extrication over a broad range of hardness, thickness and distance. All three methods tested are acceptable. The bow and arrow is not as precise in its velocity control and requires considerable skill for accuracy. The potato gun lacked the velocity control and measure of accuracy of the two previous delivery methods.

A thin nylon game tracking thread can be used as a tether to facilitate retrieval of an extricated device with its captured sample and spent projectile if conditions so favor. This thread has a sufficient tensile strength to overcome a variety of obstacles. It can be obtained at most sporting goods stores or archery centers in 3000 feet lengths. Testing this embodiment at heights up to one hundred feet above ground proved a tether tends to get in the way during operation to a disadvantage more than it aids any advantage of retrieval. A tether is not needed except to pull the device from inhospitable or dangerous terrain where it might fall after capturing a sample and extricating itself from especially hostile or unhealthy environments.

Operation

The manner in using the Self Extricating Independent Ballistic Material Core Sampler is consistent with using the projectile chosen for delivery. The device itself can be a projectile with the appropriate means of launching. With the embodiment of this prototype self extricating core sampler, it is affixed to a cross-bow bolt and launched at 250 to 300 ft./sec., sufficient velocity to reach a high or distant location and impact the material desired to be sampled with enough force to penetrate into the material. Two hundred fifty feet per second at launch is sufficient to sample hard plaster at two hundred feet. This invention begins to function on impact. When the sharpened open end opposite the breech of the core barrel 12 impacts the surface of the host matrix material inertia forces it to penetrate well into the material. The sharpened end cuts through the material forcing a core into the forward hollow part of the cylinder. The forward hollow part of the cylinder now becomes the sample chamber of the core barrel 12. As the core barrel 12 penetrates into the host material being sampled, the extricating spring 10 does not penetrate, but stops at the surface and compresses as the core barrel 12 penetrates deeper. When the core barrel 12 fills with sample material the resistance to penetration becomes much greater and approaches equilibrium with forward inertia. When forward inertial motion reaches equilibrium with resistance to penetration forward motion ceases. The extricating spring 10 is now tightly compressed. At the instant of equilibrium the extricating spring 10 releases its powerful compressed energy against the surface of the host material in which the core barrel 12 is imbedded, reversing the motion of the projectile 24 while freeing the sampler from the host material and throwing projectile 24 and the full sample chamber of the core barrel 12 away from the sampled host material. The force released by the extricating spring distances the assembly from the sampled material and it falls freely to the nearest horizontal surface. The person sampling retrieves the projectile 24 with a representative sample in cross-section compacted tightly inside the sample chamber of the core barrel 12.

The sample is removed to a suitable container and the device is cleaned and can be used many more times. For expedience in the field we simply removed the full sampling device from the projectile 24 and put an empty one back on and continued sampling with the same projectile 24.

Conclusions, Ramifications, and Scope

Accordingly, the reader will see that the self-extricating sampler of the invention provides a highly reliable, accurate, straightforward, simple, economical device that can be used safely by average persons in virtually any environment, including potentially combustible atmospheres and confined space. The self-extricating sampler provides the safety measure of keeping humans distanced from possibly toxic and/or potentially hazardous areas of uncertainty while providing the means to accurately ascertain the nature of such areas. The reader will see the advantages of the Self Extricating Independent Ballistic Material Core Sampler as did the Colorado Department of Public Health whose approval of sampling methodology was required for acceptance as a viable analytical sampling protocol. This method of sampling for asbestos in building materials is safe, clean, quick, inexpensive and collects a superior sample for analysis. Its scope is not limited to asbestos sampling. Any solid material can be retrieved from inaccessible or inhospitable areas with this device. For example, numerous aged refineries, chemical processing and production plants, power plants, weapons plants and aging nuclear generating stations all hold known and unknown dangers for humans during demolition. Further, it is not limited to inhospitable or difficult areas, a ceiling, for example, of an eighty thousand square foot warehouse can be sampled extensively without ever using a ladder or a mechanical lift. The ramifications and cost effectiveness of any sampling projects using the self extricating core sampler are revolutionary. The length and diameter of the sampler core barrel can be adjusted to adapt to the firmness, texture, depth and various adhesive qualities of any materials. This sampler is superior in terms of safety, time, economy, efficiency, uniformity and quality of sample retrieved.

The conclusion is obvious, necessity has produced a superior core sampling device capable of traveling to remote locations, capturing a representative sample and extricating itself from the host matrix with no physical connection to the origin.

Although the description above contains many specificities, these should not be construed as limiting the scope of the invention but as merely providing illustrations of some of the presently preferred embodiments of this invention. Thus the scope of this invention should be determined by the appended claims and their legal equivalents, rather than by the examples given.

I claim:

1. A self extricating material core sampler comprising a durable hollow cylinder within a surrounding helical coil extricating compression spring and a solid rod disposed protruding contingent and slidable within the breech of the cylinder lumen with a plurality of holes disposed through lumen and rod aligned to allow insertion of pins disposed protruding each end from the side of the cylinder base sufficient to impede slidability of the helical coils of the extricating compression spring contingent to the cylinder but does allow trachoidal traverse.

2. The sampler of claim 1 wherein said cylinder end opposite the breech is chamfered evert and xyresic.

3. The sampler of claim 1 wherein said cylinder is composed of metal.

4. The sampler of claim 1 wherein said spring is of a predetermined k-factor.

5. The sampler of claim 1 wherein said rod further includes a plurality of incrementally larger and smaller contingent and slidable cylindrical sleeves as a means of mating rod diameter one to the other contingent with lumen diameter.

6. The sampler of claim 1 wherein said breech end of said cylinder comprises any adaptation that attaches to any ballistic projectile.

7. Deploying a core sampler a distance greater than the reach of a human arm by means of a ballistic projectile capable of reaching a distance and urge the sampler to penetrate a material.

8. The method of claim 7 wherein said projectile is any ballistic device aimed and launched by a human.

9. Urging penetration of the sampler of claim 1 wherein said sampler is carried a distance less than the length of a human arm and by means of impacting the breech end of said sampler with any device capable to urge said sampler penetrating end beneath the surface of a material.

10. The sampler of claim 1 wherein said sampler is itself a projectile.

11. The sampler of claim 1 wherein said sampler is attached to any tether.

12. The sampler of claim 1 wherein said hollow portion sample chamber of said cylinder is urged to contain any material.

13. The sampler of claim 1 wherein said sampler is deployed a distance from the origin by means of any continuous connection.
